(19) United States
(12) Patent Application Publication
(10) Pub. No.: US 2011/0227837 A1
(43) Pub. Date: Sep. 22, 2011

(54) ELECTROMAGNETIC TOUCH DISPLAYER

(75) Inventors: Cheng-Hao Lee, Hsinchu (TW); Feng-Chuan Yeh, Hsinchu (TW); Kai-Cheng Chuang, Hsinchu (TW); Tzu-Ming Wang, Hsinchu (TW)

(73) Assignee: E INK HOLDINGS INC., Hsinchu (TW)

(21) Appl. No.: 12/853,894

(22) Filed: Aug. 10, 2010

(30) Foreign Application Priority Data
Mar. 16, 2010 (TW) 099107595

(51) Int. Cl. G06F 3/041

(52) U.S. Cl. 345/173

(57) ABSTRACT

An electromagnetic touch displayer is provided. The electromagnetic touch displayer may work with an electromagnetic signal transmission apparatus. The electromagnetic touch displayer comprises a plurality of sense antennas. When the electromagnetic touch displayer enters into a sleep mode, a part of the sense antennas will keep in the work mode. If the user wants to wake the electromagnetic touch displayer up to make it into the work mode, he will make the electromagnetic signal transmission apparatus transmit an electromagnetic signal. Then, the electromagnetic touch displayer receives the electromagnetic signal via the sense antennas which are still working, and enters into the work mode according to the electromagnetic signal.

### CROSS-REFERENCES TO RELATED APPLICATIONS

This non-provisional application claims priority under 35 U.S.C. §119(a) on Patent Application No(s). 099107595 filed in Taiwan, R.O.C. on Mar. 16, 2010, the entire contents of which are hereby incorporated by reference.

### BACKGROUND OF THE INVENTION

1. Field of the Invention

The present invention relates to an electromagnetic touch display apparatus. Specifically, the present invention relates to an electromagnetic touch display apparatus having a sleep mode.

2. Descriptions of the Related Art

Input devices are a kind of important and indispensable components among computer peripheral devices, and only through operations of the input devices users may control computers. Common computer input devices currently available in the market include keyboards, mice, presenters and the like. The users may determine which kind of input device to use according to their own needs. However, most of the input devices require the users to learn specific operating manners of such devices, for example, an operating manner of a mouse or a relatively complex input method of a keyboard. None of these operation manners is intuitive for the users.

To allow the users to operate computer systems in a more intuitive way, associated touch input devices have been developed, among which electromagnetic touch input devices are highly accepted in the market owing to their advantage of high pressure sensitivity. An electromagnetic touch input device usually comprises an electromagnetic signal transmission apparatus (e.g., a pressure-sensitive electromagnetic pen) and a digital antenna board. Through electromagnetic induction, the pressure-sensitive electromagnetic pen, as a signal transmission end, is configured to transmit an electromagnetic signal and the digital antenna board, as a signal receiving end, is configured to receive/induce the electromagnetic signal to cause variations of magnetic flux and then calculate a touch position according to the variations of the magnetic flux.

More specifically, the digital antenna board comprises a plurality of sense antennas configured to receive/induce the electromagnetic signal, and the variation extent of the magnetic flux thereof varies with distance from the pressure-sensitive electromagnetic pen. Accordingly, the digital antenna board may calculate the touch position of the pressure-sensitive electromagnetic pen according to the variations of the magnetic flux. However, in the conventional digital antenna board, whether the pressure-sensitive electromagnetic pen is transmitting an electromagnetic signal or not, all sense antennas of the convention digital antenna board have to stay in a work mode all the time, which will unnecessarily waste electrical power to result in such shortcomings as poor battery endurance of the digital antenna board.

Accordingly, efforts still have to be made in the art to provide a solution that may improve the battery endurance of the digital antenna board by increasing the utilization efficiency of the electrical power without having to change the original electromagnetic touch architecture, so as to overcome the shortcomings of the prior art.

### SUMMARY OF THE INVENTION

An objective of the present invention is to provide an electromagnetic touch displayer, which may work with an electromagnetic signal transmission apparatus. When entering into a sleep mode, the electromagnetic touch displayer will keep only a part of touch functions active to reduce power consumption.

To achieve the aforesaid objective, the electromagnetic touch displayer of the present invention comprises an electromagnetic touch circuit, a first sense antenna group and a second sense antenna group. The first sense antenna group and the second sense antenna group are electrically connected to the electromagnetic touch circuit respectively. The first sense antenna group is in a sleep mode, and the second sense antenna group is in a work mode to receive an electromagnetic signal transmitted by the electromagnetic signal transmission apparatus. According to the electromagnetic signal, the electromagnetic touch circuit generates an enable signal to the first sense antenna group which may switch into the work mode from the sleep mode according to the enable signal.

In summary, the electromagnetic touch displayer of the present invention comprises a plurality of sense antennas, some of which may enter into the sleep mode (i.e., the first sense antenna group) while the others still stays in the work mode (i.e., the second sense antenna group). When a user attempts to use the electromagnetic touch displayer, he may transmit an electromagnetic signal via the electromagnetic signal transmission apparatus to wake up the first sense antenna group into the work mode. Thereby, unnecessary power consumption of the electromagnetic touch displayer may be reduced to overcome the shortcomings of the prior art, thereby increasing the added value of the electromagnetic touch products.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a schematic view of a first embodiment of the present invention; and

FIG. 2 is a schematic view of an antenna board of the first embodiment.

### DESCRIPTION OF THE PREFERRED EMBODIMENT

In the following description, the present invention will be explained with reference to embodiments thereof. However, these embodiments are not intended to limit the present invention to any specific environment, applications or particular implementations described in these embodiments. Therefore, description of these embodiments is only for purpose of illustration rather than to limit the present invention. It should be appreciated that, in the following embodiments and the attached drawings, elements unrelated to the present invention are omitted from depiction; and dimensional relationships among individual elements in the attached drawings are illustrated only for ease of understanding, but not to limit the actual scale.

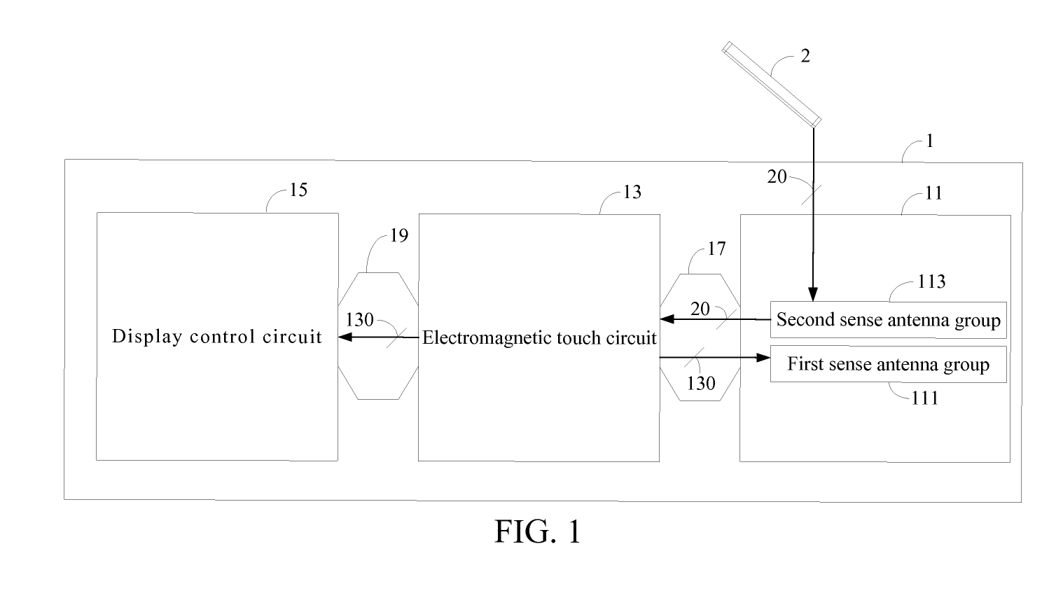

A first embodiment of the present invention is shown in FIG. 1, which is a schematic view of an electromagnetic touch display system. The electromagnetic touch display system comprises an electromagnetic touch displayer 1 and an electromagnetic signal transmission apparatus 2 adapted to transmit an electromagnetic signal 20. The electromagnetic signal transmission apparatus 2 may be a pressure-sensitive electromagnetic pen in this embodiment; however, it is not merely limited thereto, and may also be one of other apparatuses with the function of transmitting the electromagnetic signal 20 in other embodiments.

As can be known from FIG. 1, the electromagnetic touch displayer 1 comprises an antenna board 11, an electromagnetic touch circuit 13, a display control circuit 15 and flexible circuit boards (FCBs) 17 and 19. The antenna board 11 comprises a first sense antenna group 111 and a second sense antenna group 113. In other words, the electromagnetic touch displayer 1 may be regarded to comprise the first sense antenna group 111, the second sense antenna group 113, the electromagnetic touch circuit 13, the display control circuit 15 and the flexible circuit boards 17 and 19.

Connection relationships and functions of the aforesaid individual components will be described hereinafter. As can be known from FIG. 1, the first sense antenna group 111 and the second sense antenna group 113 may be electrically connected to the electromagnetic touch circuit 13 through the flexible circuit board 17, and the electromagnetic touch circuit 13 may be electrically connected to the display control circuit 15 through the flexible circuit board 19. At present, the electromagnetic touch displayer 1 is in a sleep mode, and in order to reduce power consumption, the first sense antenna group 111 and the display control circuit 15 of the electromagnetic touch displayer 1 are in the sleep mode while only the second sense antenna group 113 is in a work mode.

When the electromagnetic touch displayer 1 is to be normally operated by a user, an electromagnetic signal 20 may be transmitted by the electromagnetic signal transmission apparatus 2 within an effective receiving range of the second sense antenna group 113. As the second sense antenna group 113 is in the work mode, the electromagnetic signal 20 will be received by the second sense antenna group 113 and then transmitted to the electromagnetic touch circuit 13 through the flexible circuit board 17.

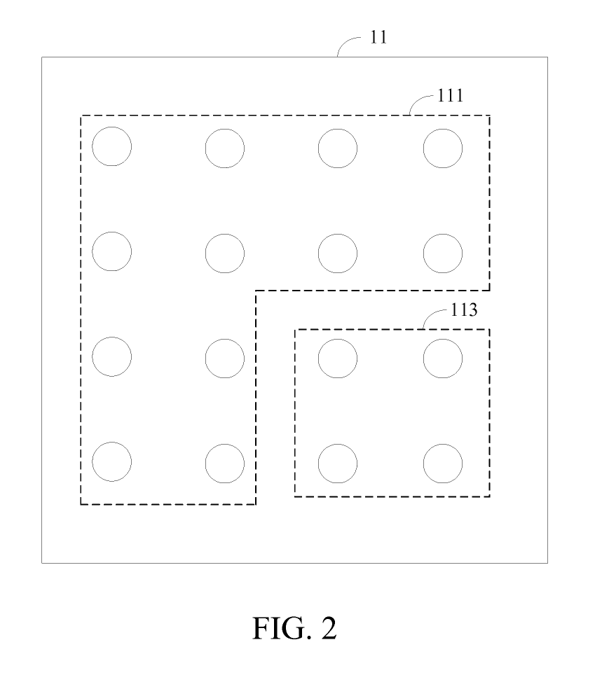

Specifically, referring to FIG. 2, it is a top view of the antenna board 11. The antenna board 11 comprises a plurality of sense antennas, and each circular symbol shown in FIG. 2 represents a sense antenna. Moreover, according to whether each of the sense antennas is in the work mode or not, the sense antennas shown in FIG. 2 may be grouped into the first sense antenna group 111 and the second sense antenna group 113. In more detail, the first sense antenna group 111 comprises the sense antennas in the sleep mode, and the second sense antenna group 113 comprises the sense antennas in the work mode. If the user desires to switch the electromagnetic touch displayer 1 into the work mode from the sleep mode, an electromagnetic signal 20 needs to be transmitted by the electromagnetic signal transmission apparatus 2 within the effective receiving range of the second sense antenna group 113, so as to have the electromagnetic touch displayer 1 enter into the work mode.

Next, upon receiving the electromagnetic signal 20, the electromagnetic touch circuit 13 learns that the user desires to normally operate the electromagnetic touch displayer 1, so it generates an enable signal 130 to the first sense antenna group 111 and the display control circuit 15 according to the electromagnetic signal 20. Thereby, the first sense antenna group 111 and the display control circuit 15 may be switched into the work mode from the sleep mode according to the enable signal 130 respectively so that the user may normally operate the electromagnetic touch displayer 1.

In summary, the electromagnetic touch displayer of the present invention comprises a plurality of sense antennas, some of which may enter into the sleep mode (i.e., the first sense antenna group) while the others still stays in the work mode (i.e., the second sense antenna group). When the electromagnetic touch displayer is used by a user, an electromagnetic signal may be transmitted by the electromagnetic signal transmission apparatus to wake up the first sense antenna group into the work mode. Thereby, unnecessary power consumption of the electromagnetic touch displayer may be reduced to overcome the shortcomings of the prior art, thereby increasing the added value of the electromagnetic touch products.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. An electromagnetic touch displayer adapted to work with an electromagnetic signal transmission apparatus, the electromagnetic signal transmission apparatus being adapted to transmit an electromagnetic signal, the electromagnetic touch displayer comprising:
an electromagnetic touch circuit;
a first sense antenna group, being electrically connected to the electromagnetic touch circuit and in a sleep mode; and
a second sense antenna group, being electrically connected to the electromagnetic touch circuit and in a work mode to receive the electromagnetic signal,
wherein the electromagnetic touch circuit generates an enable signal to the first sense antenna group according to the electromagnetic signal so that the first sense antenna group switches into the work mode from the sleep mode according to the enable signal.

2. The electromagnetic touch displayer as claimed in claim 1, wherein the second sense antenna group has an effective receiving range and may receive the electromagnetic signal when the electromagnetic signal transmission apparatus is located within the effective receiving range.

3. The electromagnetic touch displayer as claimed in claim 1, further comprising a flexible circuit board, wherein the first sense antenna group and the second sense antenna group are electrically connected to the electromagnetic touch circuit through the flexible circuit board so that the second sense antenna group may transmit the electromagnetic signal to the electromagnetic touch circuit through the flexible circuit board, and the electromagnetic touch circuit may transmit the enable signal to the first sense antenna group through the flexible circuit board.

4. The electromagnetic touch displayer as claimed in claim 1, further comprising a display control circuit electrically connected to the electromagnetic touch circuit and in the sleep mode, wherein the electromagnetic touch circuit is further configured to transmit the enable signal to the display control circuit, and the display control circuit is configured to switch into the work mode from the sleep mode according to the enable signal.

5. The electromagnetic touch displayer as claimed in claim 4, further comprising a flexible circuit board, wherein the display control circuit is electrically connected to the electromagnetic touch circuit through the flexible circuit board so that the electromagnetic touch circuit may transmit the enable signal to the display control circuit through the flexible circuit board.
